(19) United States
(12) Patent Application Publication
(10) Pub. No.: US 2016/0346934 A1
(43) Pub. Date: Dec. 1, 2016

(54) PRESSURE SENSOR, MECHANICAL ARM AND ROBOT WITH SAME

(71) Applicant: HON HAI PRECISION INDUSTRY CO., LTD., New Taipei (TW)

(72) Inventor: JEN-TSORNG CHANG, New Taipei (TW)

(21) Appl. No.: 14/928,277

(22) Filed: Oct. 30, 2015

(30) Foreign Application Priority Data
May 27, 2015 (CN) 201510276615.1

(51) Int. Cl. B25J 9/16; B25J 13/08; G01L 1/12

(52) U.S. Cl. CPC B25J 9/1694; G01L 1/12; B25J 13/085

(57) ABSTRACT

A pressure sensor includes a base, a plurality of magneto-dependent sensors coupled to a face of the base, a deformable layer and a magnetic layer. The deformable layer is coupled to the plurality of magneto-dependent sensors. The magnetic layer is coupled to the deformable layer. The magnetic layer produces a magnetic field. The deformable layer and the plurality of magneto-dependent sensors are located in the magnetic field. The magnetic layer presses the deformable layer to deform when a pressure is exerted to the magnetic layer. Each of the plurality of magneto-dependent sensors produces an electric signal. The electric signals produced by the plurality of magneto-dependent sensors are in direct proportion to value of the pressure exerted to positions of the magnetic layer which are corresponding to the plurality of magneto-dependent sensors. A mechanical arm and a robot with the pressure sensor are also provided.

### FIELD

The subject matter herein generally relates to sensing technology, and particularly to a pressure sensor, a mechanical arm with the pressure sensor, and a robot with the pressure sensor.

### BACKGROUND

Robot is a machine automatically performing work, to assist or replace human to work. With the development of robot technology, applied fields of the robot are more and more. Humanoid robot is a research direction to realize the man-machine interaction. Currently, some mechanical hands of robot are equipped with pressure sensors to have function of perceiving pressure.

### BRIEF DESCRIPTION OF THE DRAWINGS

Implementations of the present technology will now be described, by way of example only, with reference to the attached figures.

FIG. 1 is a diagrammatic view of a robot with two mechanical arms in accordance with an embodiment of the present disclosure.

FIG. 2 is a diagrammatic view of a pressure sensor of the mechanical arm in FIG. 1.

FIG. 3 is a cross sectional view of the pressure sensor in FIG. 2, taken along a line

FIG. 4 is a cross sectional view of the pressure sensor similar to the view in FIG. 3, but in a different state.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a pressure sensor. The pressure sensor can include a base, a plurality of magneto-dependent sensors coupled to a face of the base, a deformable layer and a magnetic layer. Each of the plurality of magneto-dependent sensors has a face remote from the base. The deformable layer is coupled to the faces of the plurality of magneto-dependent sensors remote from the first base and has a face remote from each of the plurality of magneto-dependent sensors. The magnetic layer is coupled to the face of the deformable layer remote from the plurality of magneto-dependent sensors. The magnetic layer produces a magnetic field. The deformable layer and the plurality of magneto-dependent sensors are located in the magnetic field. The magnetic layer presses the deformable layer to deform when a pressure is exerted to the magnetic layer. Each of the plurality of magneto-dependent sensors produces an electric signal. The electric signals produced by the plurality of magneto-dependent sensors are in direct proportion to value of the pressure exerted to positions of the magnetic layer which are corresponding to the plurality of magneto-dependent sensors.

The present disclosure is described further in relation to a mechanical arm. The mechanical arm can include an arm and a plurality of pressure sensors coupled to different positions of the arm. Each of the pressure sensors can include a base, a plurality of magneto-dependent sensors coupled to a face of the base, a deformable layer and a magnetic layer. The deformable layer is coupled to faces of the plurality of magneto-dependent sensors remote from the first base. The magnetic layer is coupled to a face of the deformable layer remote from the plurality of magneto-dependent sensors. The magnetic layer produces a magnetic field. The deformable layer and the plurality of magneto-dependent sensors are located in the magnetic field. The magnetic layer presses the deformable layer to deform when a pressure is exerted to the magnetic layer. Each of the plurality of magneto-dependent sensors produces an electric signal. The electric signals produced by the plurality of magneto-dependent sensors are in direct proportion to value of the pressure exerted to positions of the magnetic layer which are corresponding to the plurality of magneto-dependent sensors.

The present disclosure is described further in relation to a robot. The robot can include a body, a mechanical arm coupled to the body and a plurality of pressure sensors coupled to different positions of the mechanical arm. Each of the pressure sensors can include a base, a plurality of magneto-dependent sensors coupled to a face of the base, a deformable layer and a magnetic layer. The deformable layer is coupled to faces of the plurality of magneto-dependent sensors remote from the first base. The magnetic layer is coupled to a face of the deformable layer remote from the plurality of magneto-dependent sensors. The magnetic layer produces a magnetic field. The deformable layer and the plurality of magneto-dependent sensors are located in the magnetic field. The magnetic layer presses the deformable layer to deform when a pressure is exerted to the magnetic layer. Each of the plurality of magneto-dependent sensors produces an electric signal. The electric signals produced by the plurality of magneto-dependent sensors are in direct proportion to value of the pressure exerted to positions of the magnetic layer which are corresponding to the plurality of magneto-dependent sensors.

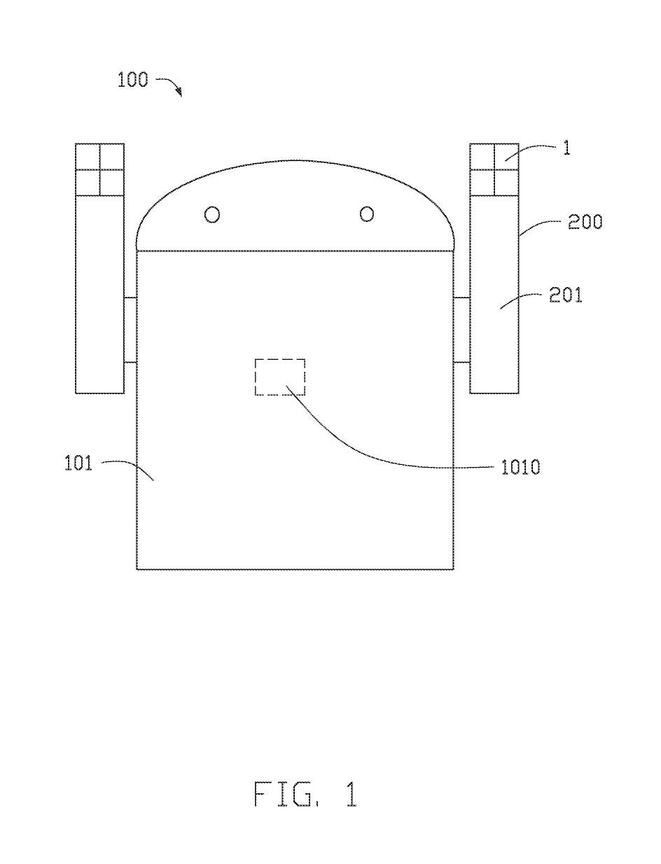

FIG. 1 illustrates a robot 100 with two mechanical arms 200 of an embodiment of the present disclosure. The robot 100 can include a body 101 and the two mechanical arms 200 mounted to two opposite sides of the body 101.

Each mechanical arm 200 can include an arm 201 and a plurality of pressure sensors 1 coupled to different positions of a surface of the arm 201. The pressure sensors 1 are configured to detect pressure at the different positions of the surface of the mechanical arm 200.

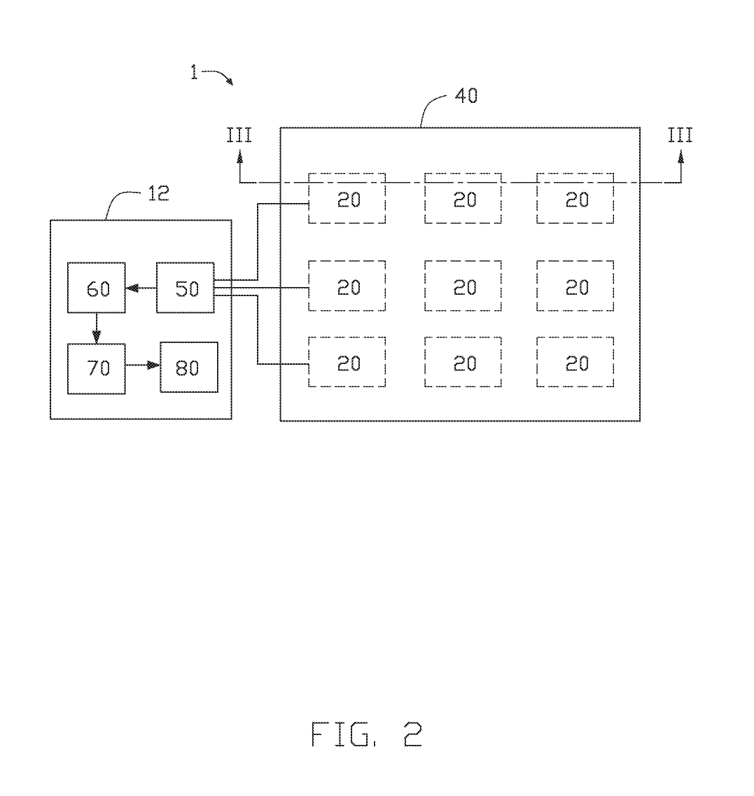

FIG. 2 illustrates that each pressure sensor 1 can include a first part and a second part electrically coupled to the first portion.

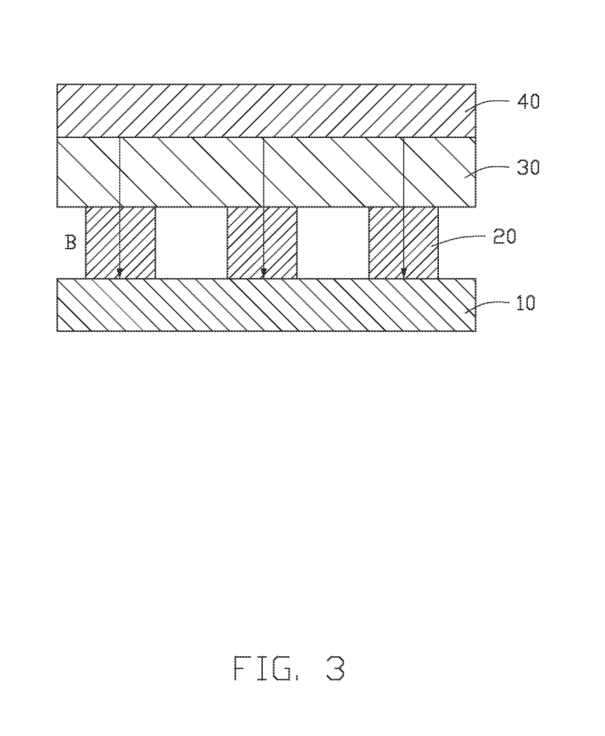

FIG. 3 illustrates that the first part of each pressure sensor 1 can include a first base 10, a plurality of magneto-dependent sensors 20 coupled to a face of the first base 10, a deformable layer 30 coupled to faces of the magneto-dependent sensors 20 remote from the first base 10, and a magnetic layer 40 coupled to a face of the deformable layer 30 remote from the magneto-dependent sensors 20. In the illustrated embodiment, the magneto-dependent sensors 20 are located on the first base 10. The magneto-dependent sensors 20 are located between the first base 10 and the deformable layer 30. The deformable layer 30 is located on the magneto-dependent sensor 20. The deformable layer 30 is located between the magneto-dependent sensors 20 and the magnetic layer 40. The magnetic layer 40 is located on the deformable layer 30.

The first base 10 can be a printed circuit board. In at least one embodiment, the first base 10 can be a flexible printed circuit board.

Each magneto-dependent sensor 20 is configured to produce an electric signal when the magneto-dependent sensor 20 is in a magnetic field of the magnetic layer 40. The electric signal can be a voltage signal or a current signal. In at least one embodiment, each magneto-dependent sensor 20 can be in directly physical contact with the first base 10. The plurality of magneto-dependent sensors 20 are spaced form each other. In at least one embodiment, the plurality of magneto-dependent sensors 20 are spaced from each other with a constant interval between every two adjacent ones. Each of the magneto-dependent sensors 20 can be a Hall sensor.

The plurality of magneto-dependent sensors 20 are arranged on the first base 10 in a matrix (shown in FIG. 2). A number and positions of the plurality of magneto-dependent sensors 20 can be arranged according to actual needs. In the illustrated embodiment, the number of the plurality of magneto-dependent sensors 20 is nine and arranged in a 3×3 matrix (shown in FIG. 2). In at least one alternative embodiment, the number of the plurality of magneto-dependent sensors 20 is sixteen and arranged in a 4×4 matrix.

The deformable layer 30 is a layer prone to be elastic deformed under pressure. Material of the deformable layer 30 can be one or more selected from polydimethylsiloxane, ethyl urethane, rubber, silicon gel or other materials with property of elastic deformation under pressure. In at least one embodiment, a thickness of the deformable layer 30 is less than 10 millimeters.

The magnetic layer 40 is configured to produce the magnetic field. The plurality of magneto-dependent sensors 20 and the deformable layer 30 are located in the magnetic field. Material of the magnetic layer 40 can be nickel base alloy or rare earth alloy. In at least one embodiment, the magnetic layer 40 can be a thin film of ferro-nickel formed by physical vapor deposition or electroplating method. The magnetic layer 40 has a thickness ensuring that the magnetic layer 40 can be deformed under pressure to press the deformable layer 30. In at least one embodiment, the magnetic layer 40 has the thickness less than 100 micrometers.

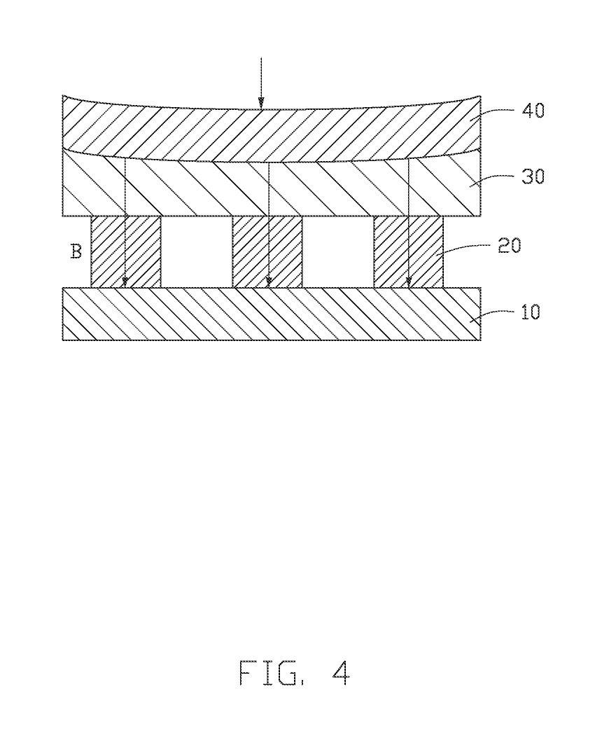

FIG. 4 illustrates that the magnetic layer 40 presses the deformable layer 30 under a pressure. The deformable layer 30 is deformed to have different thicknesses along a direction parallel to the first base 10. The deformable layer 30 has different thicknesses at different positions thereof.

A distance is defined between each of the plurality of magneto-dependent sensors 20 and the magnetic layer 40. When the deformable layer 30 is deformed, the distances between the plurality of magneto-dependent sensors 20 and the magnetic layer 40 are different. Therefore, the plurality of magneto-dependent sensors 20 are suffered different magnetic field intensity in the magnetic field of the magnetic layer 40. The electric signals produced by the plurality of magneto-dependent sensors 20 are in direct proportion to the magnetic field intensity in the magnetic field of the magnetic layer 40 corresponding to the magneto-dependent sensors 20. In another word, the electric signals produced by the plurality of magneto-dependent sensors 20 are in direct proportion to value of the pressure exerted to positions of the magnetic layer 40 which are corresponding to the plurality of magneto-dependent sensors.

When the magnetic layer 40 suffers a first pressure a first position thereof, and suffers a second pressure at a second portion thereof, the first pressure is less than the second pressure, the first position is different from the second position, a first distance between the magnetic layer 40 and the magneto-dependent sensor 20 corresponding to the first position of the magnetic layer 40 is larger than a second distance between the magnetic layer 40 and the magneto-dependent sensor 20 corresponding to the second position of the magnetic layer 40, therefore, the magneto-dependent sensor 20 corresponding to the first position of the magnetic layer 40 is suffered a first magnetic field intensity less than a second magnetic field intensity suffered by the magneto-dependent sensor 20 corresponding to the second position of the magnetic layer 40. Therefore, a first electric signal produced by the magneto-dependent sensor 20 corresponding to the first position of the magnetic layer 40 is weaker than a second electric signal produced by the magneto-dependent sensor 20 corresponding to the second position of the magnetic layer 40.

FIG. 2 illustrates that the second part of each pressure sensor 1 further includes a second base 12, a multiplexer 50, a filter 60, a digital to analog converter 70 and a controller 80. Each of the multiplexer 50, the filter 60, the digital to analog converter 70 and the controller 80 is coupled to the second base 12. The filter 60 is electrically connected to the plurality of magneto-dependent sensors 20 via the multiplexer 50. The digital to analog converter 70 is electrically coupled to the filter 60. The controller 80 is electrically coupled to the digital to analog converter 70.

The multiplexer 50 can include a plurality of sub-channels coupled to corresponding magneto-dependent sensors 20. The multiplexer 50 is configured to scan round each sub-channel orderly, and collect the electric signal transmitted by corresponding sub-channel from each magneto-dependent sensor 20.

The filter 60 is configured to filter the electrical signal.

The digital to analog converter 70 is configured to convert the electric signals in analog format after filtered by the filter 60 to be electric signals in digital format.

The controller 80 is configured to calculate the value of the pressure exerted to the position of the magnetic layer 40 which is corresponding to the magneto-dependent sensor 20 produced the electric signal, according to the electric signal in digital format. Therefore, the pressure sensor 1 can detect pressure distribution at different positions of a surface thereof, when the pressure is exerted to the surface of the pressure sensor 1, which provides pressure sensing sensitivity to the robot 100 with the pressure sensor 1.

FIG. 1 illustrates that the robot 100 further includes a central processor 1010 located in the body 101. The central processor 1010 is electrically coupled to the controller 80. The central processor 1010 is configured to obtain the value of the pressure calculated by the controller 80, and control the robot 100 to perform corresponding actions (such as provide vibration feedback) according to the value of the pressure.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A pressure sensor comprising:
a base having a face;
a plurality of magneto-dependent sensors coupled to a face of the base, each of the plurality of magneto-dependent sensors having a face remote from the base;
a deformable layer coupled to the faces of the plurality of magneto-dependent sensors remote from the first base and having a face remote from the plurality of magneto-dependent sensors; and
a magnetic layer coupled to the face of the deformable layer remote from the plurality of magneto-dependent sensors and configured to produce a magnetic field, wherein the deformable layer and the plurality of magneto-dependent sensors are located in the magnetic field;
wherein the magnetic layer presses the deformable layer to deform when a pressure is exerted to the magnetic layer, each of the plurality of magneto-dependent sensors produces an electric signal, which is in direct proportion to a value of the pressure exerted to positions of the magnetic layer, at corresponding locations of the plurality of magneto-dependent sensors.

2. The pressure sensor of claim 1, further comprising an additional base, a multiplexer, a filter, a digital to analog converter and a controller, wherein each of the multiplexer, the filter, the digital to analog converter and the controller is coupled to the second base, the multiplexer being configured to collect the electric signal from each magneto-dependent sensors, the filter being configured to filter the electrical signal, the digital to analog converter being configured to convert the electric signal in analog format after filtered by the filter to be electric signal in digital format, the controller being configured to calculate the value of the pressure exerted to the position of the magnetic layer which is corresponding to the magneto-dependent sensor according to the electric signal in digital format.

3. The pressure sensor of claim 2, wherein the filter is electrically connected to the plurality of magneto-dependent sensors via the multiplexer, the digital to analog converter being electrically coupled to the filter, the controller being electrically coupled to the digital to analog converter.

4. The pressure sensor of claim 1, wherein the magnetic layer is a thin film of ferro-nickel.

5. The pressure sensor of claim 1, wherein the magnetic layer has a thickness less than 100 micrometers.

6. The pressure sensor of claim 1, wherein the deformable layer is one or more selected from polydimethylsiloxane, ethyl urethane, rubber, silicon gel or other materials with property of deformation under pressure.

7. The pressure sensor of claim 1, wherein the deformable layer has a thickness less than 10 millimeters.

8. The pressure sensor of claim 1, wherein the plurality of magneto-dependent sensors are arranged on the base in a matrix.

9. The pressure sensor of claim 1, wherein each of the magneto-dependent sensors is a Hall sensor.

10. The pressure sensor of claim 1, wherein the base is a printed circuit board.

11. A mechanical arm comprising:
an arm and a plurality of pressure sensors coupled to different positions of the arm, each of the pressure sensors comprising:
a base;
a plurality of magneto-dependent sensors coupled to a face of the base, each of the plurality of magneto-dependent sensors having a face remote from the base;
a deformable layer coupled to the faces of the plurality of magneto-dependent sensors remote from the first base and having a face remote from each of the plurality of magneto-dependent sensors; and
a magnetic layer coupled to the face of the deformable layer remote from the plurality of magneto-dependent sensors and producing a magnetic field, wherein the deformable layer and the plurality of magneto-dependent sensors are located in the magnetic field;
wherein the magnetic layer presses the deformable layer to deform when a pressure is exerted to the magnetic layer, each of the plurality of magneto-dependent sensors produces an electric signal, the electric signals produced by the plurality of magneto-dependent sensors are in direct proportion to value of the pressure exerted to positions of the magnetic layer which are corresponding to the plurality of magneto-dependent sensors.

12. The mechanical arm of claim 11, wherein each of the pressure sensors further comprises a multiplexer, a filter, a digital to analog converter and a controller, the multiplexer being configured to collect the electric signal from each magneto-dependent sensors, the filter being configured to filter the electrical signal, the digital to analog converter being configured to convert the electric signal in analog format after filtered by the filter to be electric signal in digital format, the controller being configured to calculate the value of the pressure exerted to the position of the magnetic layer which is corresponding to the magneto-dependent sensor according to the electric signal in digital format.

13. The mechanical arm of claim 12, wherein the filter is electrically connected to the plurality of magneto-dependent sensors via the multiplexer, the digital to analog converter being electrically coupled to the filter, the controller being electrically coupled to the digital to analog converter.

14. The mechanical arm of claim 11, wherein the magnetic layer is a thin film of ferro-nickel.

15. The mechanical arm of claim 11, wherein the magnetic layer has a thickness less than 100 micrometers.

16. The mechanical arm of claim 11, wherein the deformable layer is one or more selected from polydimethylsiloxane, ethyl urethane, rubber, silicon gel or other materials with property of deformation under pressure.

17. The mechanical arm of claim 11, wherein the deformable layer has a thickness less than 10 millimeters.

18. The mechanical arm of claim 11, wherein the plurality of magneto-dependent sensors are arranged on the base in a matrix.

19. A robot comprising:
a body, a mechanical arm coupled to the body and a plurality of pressure sensors coupled to different positions of the mechanical arm, each of the pressure sensors comprising:
a base;
a plurality of magneto-dependent sensors coupled to a face of the base and each having a face remote from the base;
a deformable layer coupled to the faces of the plurality of magneto-dependent sensors remote from the first base and having a face remote from each of the plurality of magneto-dependent sensors; and
a magnetic layer coupled to the face of the deformable layer remote from the plurality of magneto-dependent sensors and producing a magnetic field, wherein the deformable layer and the plurality of magneto-dependent sensors are located in the magnetic field;
wherein the magnetic layer presses the deformable layer to deform when a pressure is exerted to the magnetic layer, each of the plurality of magneto-dependent sensors produces an electric signal, the electric signals produced by the plurality of magneto-dependent sensors are in direct proportion to value of the pressure exerted to positions of the magnetic layer which are corresponding to the plurality of magneto-dependent sensors.

20. The robot of claim 19, further comprising a central processor located in the body, wherein the central processor is electrically coupled to the pressure sensors, the central processor being configured to obtain the value of the pressure calculated by each of the pressure sensors, and control the robot to perform corresponding actions according to the value of the pressure.
